(19) United States
(12) Patent Application Publication
(10) Pub. No.: US 2002/0080139 A1
(43) Pub. Date: Jun. 27, 2002

(54) Apparatus and method of interactive model generation using multi-images

(76) Inventors: Bon-Ki Koo, Taejon (KR); Jong-Seung Park, Taejon (KR); Min-Suk Lee, Taejon (KR); Kwang-Man Oh, Taejon (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/842,343

(22) Filed: Apr. 24, 2001

(30) Foreign Application Priority Data
Dec. 27, 2000 (KR) 2000-83293

(51) Int. Cl. G06T 13/00

(52) U.S. Cl. 345/473

(57) ABSTRACT

An apparatus for interactive model generation using multi-images includes an image capturing means for capturing an arbitrary object as a 2D image using a camera, a modeler graphic user interface means for providing a 3D primitive model granting interactive relation of data between 2D and 3D, a 3D model generation means for, matching a predetermined 3D primitive model and the 2D image obtained from the image capturing means, a texture rendering means for correcting errors generated in capturing the image and an interactive animation means for adding and editing animations of various types at the 3D model for the 2D images.

### FIELD OF THE INVENTION

The present invention relates to an apparatus and method of interactive model generation using multi-images; and, more particularly, an apparatus and method for resolving a problem requiring a plurality of manipulations in generating a 3D model based on 2D images.

Description of the Prior Art Recently, as a demand of a 3D model generation tool is increasing with the generalization of internet, a necessity for a 3D model generation tool that a user can easily generate a 3D model is increased. But, a user has to learn professional skills in order to use a conventional tool and a plurality of manipulations are required in generating the 3D model.

As an example, a method of 3D model generation using images is disclosed in U.S. Pat. No. 6,061,468, entitled “Method for reconstructing a three-dimensional object from a closed-loop sequence of images taken by an uncalibrated camera,” issued on May 9, 2000 and assigned to “Compaq Computer Corporation”. The patent method for obtaining 3D construction of an object from closed-loop sequence of 2D images taken by an uncalibrated camera are illustrated in detail. In one specific type of closed-loop sequence, the object can rotate around a fixed camera and alternatively, the camera can rotate around a fixed object. The method indicates that an image-based object function is minimized to extract structure and motion parameters after selecting figure points using a pair-wise image registration technique. The method described in the patent just takes sequential images for an object through rotation of a camera or an object to obtain a 3D construction. However, in this method described in the patent, a function forming a 3D model through interaction for an arbitrary image is not implemented.

As described in the above, even if a tool applying that a general user can easily generaFe 3D model is required, present tools do not satisfy the requirements.

### SUMMARY OF THE INVENTION

It is, therefore, an object of the present invention to provides an apparatus and method of interactive model generation using multi-images and a computer-readable record media storing instructions for performing the apparatus and method of interactive model generation using multi-images.

In accordance with an aspect of the present invention, there is provided an apparatus for interactive model generation using multi-images, comprising: an image capturing means for capturing an arbitrary object as a 2D image using a camera; a modeler graphic user interface means for providing a 3D primitive model granting interactive relation of data between 2D and 3D; a 3D model generation means for matching a predetermined 3D primitive model and the 2D image obtained from the image capturing means; a texture rendering means for correcting errors generated in capturing the image; and an interactive animation means for adding and editing animation of various types at the 3D model for the 2D images.

In accordance with another aspect of the present invention, there is provided a method for interactive model generating using multi-images, comprising the steps of: a) capturing means for capturing an arbitrary object as a 2D image using a camera; b) providing a 3D primitive model granting interactive relation of data between 2D and 3D; c) matching a predetermined 3D primitive model and the 2D image obtained from the image capturing means; d) correcting errors generated in capturing the image; and e) adding and editing animation of various types in the 3D model for the 2D images.

In accordance with further another aspect of the present invention, there is provided, in the interactive model generation apparatus equipped with a mass-storage processor, a computer-readable record media storing instructions for performing the functions of A method for interactive model generating using multi-images, comprising the steps of: capturing means for capturing an arbitrary object as a 2D image using a camera; providing a 3D primitive model granting interactive relation of data between 2D and 3D; matching a predetermined 3D primitive model and the 2D image obtained from the image capturing means; correcting errors generated in capturing the image; and adding and editing animation of various types in the 3D model for the 2D images.

### BRIEF DESCRIPTION OF THE DRAWINGS

The above and other objects and features of the present invention will become apparent from the following description of preferred embodiment given in conjunction with the accompanying drawings, in which:

FIG. 1 is a block diagram illustrating an apparatus and method of interactive model generation using multi-images according to the present invention;

FIG. 2 is a block diagram illustrating an image-capturing module according to the present invention;

FIG. 3 is a flow chart showing a modeler graphic user interface (GUI) module according to the present invention;

FIG. 4 is a block diagram illustrating a 3D generation module according to the present invention;

FIG. 5 is a flow chart showing a texture-rendering module according to the present invention; and

FIG. 6 is a block diagram illustrating an interactive animation module according to the present invention.

### DETAILED DESCRIPTION-OF THE PREFERRED EMBODIMENTS

Hereinafter, an apparatus and method of interactive model using multi-images according to the present invention will be described in detail referring to the accompanying drawings.

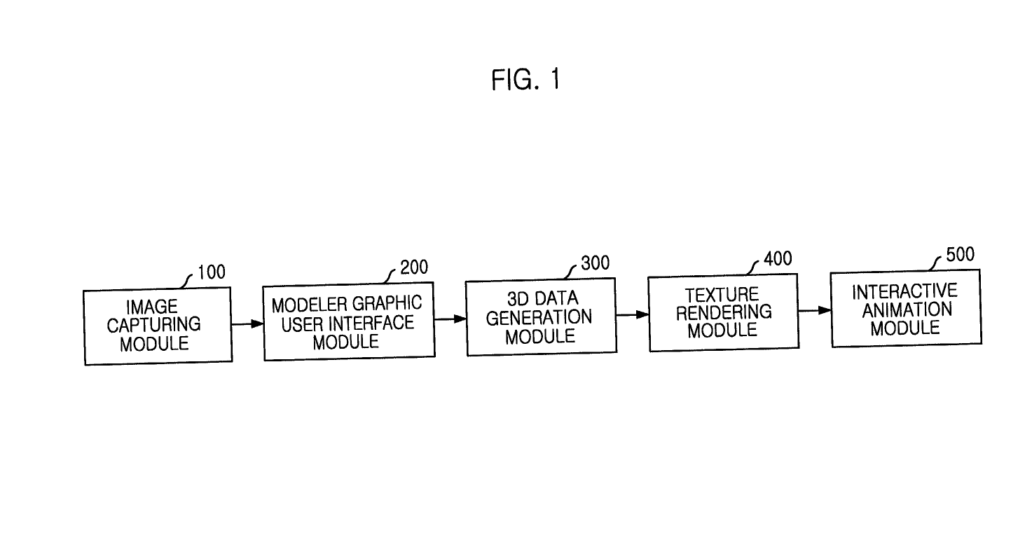

FIG. 1 is a block diagram illustrating an apparatus of interactive model generation using multi-images. Referring to FIG. 1, the apparatus of interactive model generation using multi-images according to the present invention includes an image-capturing module 100, a modeler graphic user interface module 200, a 3D data generation module 300, a texture rendering module 400 and an interactive animation module 500.

The image-capturing module 100 captures an arbitrary object that is a 2D image using a camera or a digital camera. The modeler graphic user interface module 200 provides a predetermined 3D primitive model granting an interactive relation of data between 2D and 3D and provides user interfaces based on total sequential graphics in order to display results, which output data inputted from the modeler graphic user interface module 100, on the screen. The 3D model generation module 300 implements a work to match each point of a picture with the predetermined 3D primitive model after mouse click for a predetermined 3D primitive model that is matched with a desired 3D model for the 2D image inputted from the modeler user interface module 200. The texture rendering module 400 reconstructs the damaged image in order to easily see the 2D image in case that the 2D image is damaged due to illumination or the other errors when the 2D image is captured from the 3D model -obtained by the modeler user interface module 200 and the 3D model generation module 300 and substitutes suitable parts of the other 2D image for screened parts of the 2D image and the picture (hereinafter, texture) constructing surfaces of the 3D model and an object in the 2D image that a desired 3D model is screened by the other object. The interactive animation module 500 implements addition and deletion of animations of various types, such as rotation, movement or the like, in the 3D model for the 2D images made through the image capturing module 100, the modeler graphic user interface module, the 3D data generation module 300 and the texture rendering module 400.

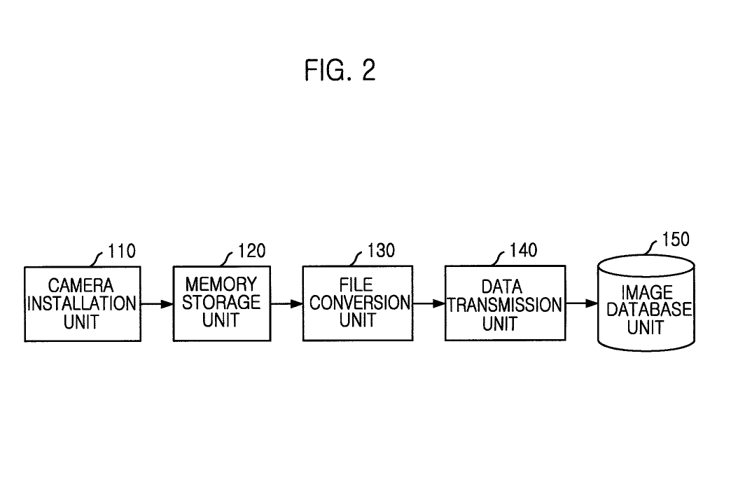

FIG. 2 is a block diagram illustrating the modeler graphic user interface module. As described in FIG. 2, the modeler graphic user interface module includes a camera installation unit 110, a memory storage unit 120, a file conversion unit 130, a data transmission unit 140 and an image database 150.

The camera installation unit 110 controls a diaphragm and focus for the object after turning on a camera in order to operate a camera or a digital camera. The memory storage unit 120 stores 2D images in a memory captured from the camera installation unit 110. The file conversion unit 130 converts a 2D image data file, which is a digitized file type stored in the modeler graphic user interface module through the memory storage unit 120, into a graphic data file that can be used in a graphic program environment. The data transmission unit 140 transmits the graphic file converted in the file conversion unit 130 to a computer database and stores the graphic data in the database. The image database unit 150 stores the graphic data transmitted by the data transmission unit 140.

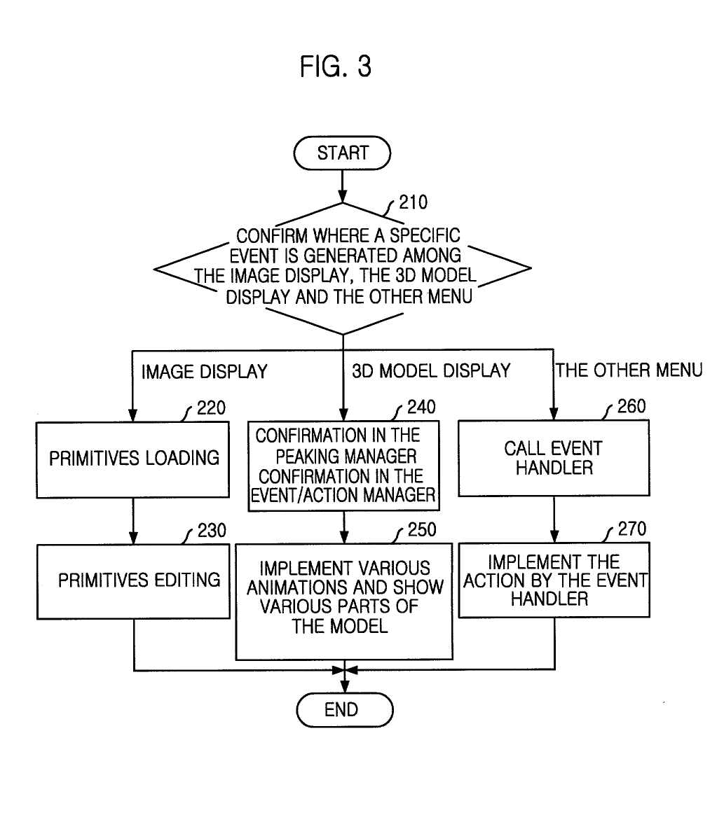

FIG. 3 is a flow diagram showing the 3D data generation module of FIG. 1 according to the present invention. The modeler user interface module includes an image display and a 3D model display. The image display is a window for displaying 2D images captured from a camera and the 3D model display is a window for displaying the 3D model. Accordingly, the modeler user interface module firstly confirms where a specific event is generated among the image display, the 3D model display and the other menu at step 210. If a mouse input is applied for the image display, several predetermined actions are implemented. After the image for constructing the 3D model is displayed on the image display, the primitives for constructing the 3D model are loaded from a primitive library at step 220. The loaded primitives are displayed on the image display in the image. Vertices of the displayed primitives can be easily edited at step 230. Herein, the basic primitives are cube, plane, pyramid and wedge of a 3D type.

When each kind of primitives for constructing the 3D model is edited in the image display, the 3D model is built in the 3D model generation module and the 3D model is displayed on the 3D model display. The model displayed on the 3D model display implements various actions according to an input of a user. Namely, a picking manager confirms which part is pushed in the model and an event/action manager confirms which event for the pushed part of the model is generated at step 240. The determined action is implemented according to the confirmed event at step 250. A user can see various parts of the model through movement of camera location or implementation of various animations according to the predetermined action.

In case that a user's input is applied for the other menu, an event handler is called at step 260 and the predetermined actions are implemented by the event handler at step 270.

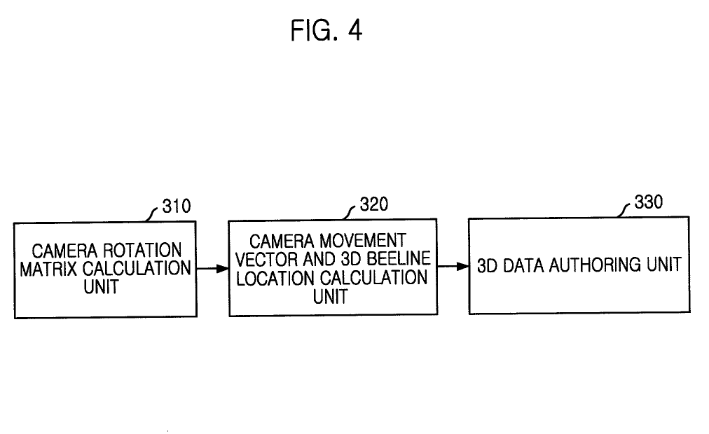

FIG. 4 is a block diagram illustrating the 3D model generation module according to the present invention. As described in FIG. 4, the 3D model generation module includes a camera rotation matrix calculation unit 310, a camera movement vector and 3D location calculation unit 320 and a 3D data authoring unit 330.

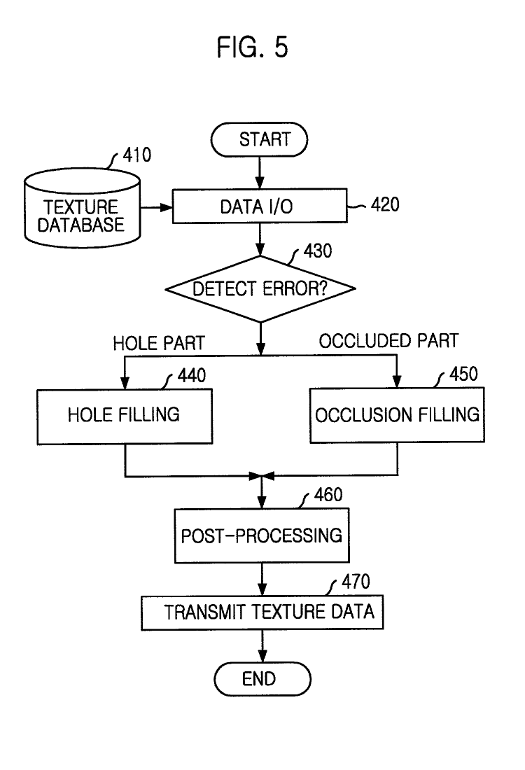

The camera rotation matrix calculation unit 310 calculates a camera rotation matrix by using some line segments of predefined primitives-cube, plane, pyramid and wedge. The method for finding the camera rotation matrix is calculated by traditional mathematical geometry algorithm. The camera movement vector and 3D location calculation unit 320 calculates a camera movement vector and 3D location using the camera rotation matrix obtained from the camera rotation matrix calculation unit 310. The 3D data authoring unit 330 stores the camera rotation matrix obtained from the camera rotation matrix calculation unit 310 and the camera movement vector and 3D location from the camera movement vector and 3D location calculation unit 320. Also the 3D data authoring unit 330 provides a suitable initial value for the camera rotation matrix, camera movement vector and 3D location using the global optimization algorithm when user requests. FIG. 5 is a flow chart showing the operation procedure of the texture-rendering module according to the present invention. As described in FIG. 5, the texture rendering module solves problems that a hole is generated because some objects in the 2D image are screened by the other objects due to the illumination or the other errors generated when the 2D image is captured from the 3D modes and multi-images constructing surfaces of the 3D model or because the texture is damaged due to errors generated in making the 3D model data or due to camera problems in capturing the image.

Errors are detected in order to input/output data at step 420 after graphic data, which is a texture, is read by a texture database 410 to manage files storing texture images. Namely, Errors are detected in order to separate a holed part and an occluded part through detection of each pixel of the read texture. In the result of the above detection, if the hole is detected, the hole is filled with adjacent pixel value at step 440 and if the occlusion by the other object is detected, the occlusion is filled with the picture of an image which is taken by a shot in a different angle at step 450. In post-processing, brightness is adjusted in order to easily see the image at step 460. The final texture image is transmitted, as a surface picture of the 3D model and texture data to renew a picture image is transmitted at step 470.

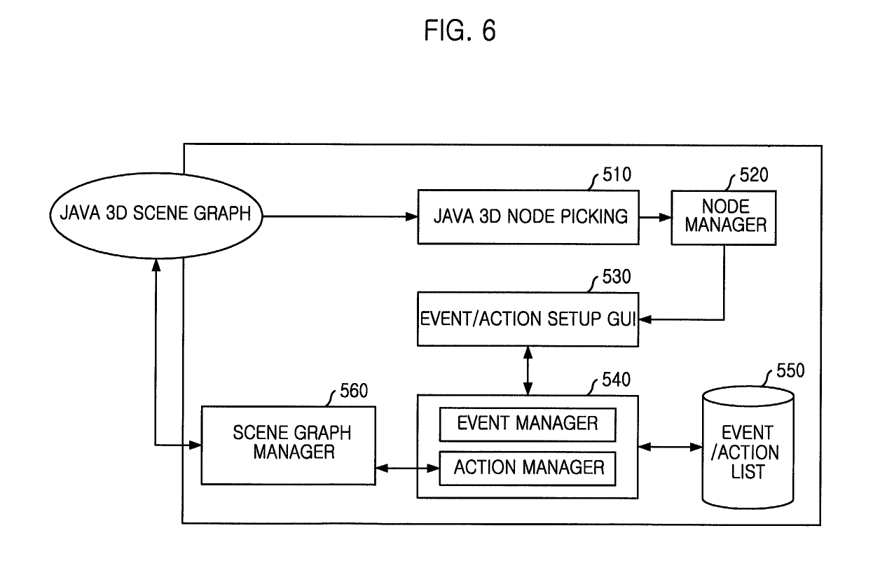

FIG. 6 is a block diagram illustrating an operation procedure of the interactive animation module according to the present invention. As described in FIG. 6, the interactive animation module includes a java 3D node picking unit 510, a node manager 520, an event/action setup graphic user interface (GUI) unit 530, an event/action list unit 550 and a scene graph manager 560. FIG. 6 basically shows an operation in the 3D model display of the modeler GUI. The java 3D node peaking unit 510 selects a specific part of a model with a shape-3D -picking-way and the selected node is managed by the node manager 520. The event/action setup GUI 530 sets up necessary actions when regular events are generated by a user at the scene graph node. The events/actions that are set up are stored in the event/action list 550 and managed by the event/action manager 540. The whole scene graphs for implementing a specific animation are managed by the scene graph manager 560.

When a mouse input is applied in the 3D model display, the java 3D node pinking unit 510 selects the node corresponding to a specific part of the selected model. If an event/action list selected by the event/action GUI exists in the selected node, the corresponding action is implemented by the event/action manager 540. Various parameters necessary for implementing animations, such as an interpolator for location change of the node selected by a user according to time change, an alpha value for adjusting time and a transform group for the interpolator, are set up in the event/action setup GUI unit 530. The scene graph manager 560 managing the whole scene graph for the 3D model changes corresponding scene graphs for the animation using the various parameters. The changed scene graph for the animation is restored when the corresponding event/action list in the event/action GUI is disappeared.

The present invention is used in the 3D modeling based on images as the interactive model for generating 3D model from 2D image captured by a camera or digital camera is generated. Also the present invention can be used in easily making a model relating of 3D web contents.

The method of the present invention as afore-described is embodied by a computer program and this program can be stored in the computer-readable record media, such as a CDROM, a RAM, a ROM, a floppy disk and a magnetic-optical disk, etc.

It will be apparent to those skilled in the art that various modification and variations can be made in the present invention without deviating from the spirit or scope of the invention. Thus, it is intended that the present invention cover the modification and variations of this invention provided they come within the scope of the appended claims and their equivalents.

What is claimed is:

1. An apparatus for interactive model generation using multi-images, comprising:
an image capturing means for capturing an arbitrary object as a two-dimensional (2D) image using a camera;
a modeler graphic user interface means for providing a three-dimensional (3D) primitive model granting interactive relation of data between 2D and 3D;
a 3D model generation means for matching a predetermined 3D primitive model and the 2D image obtained from the image capturing means;
a texture rendering means for correcting errors generated in capturing the image; and
an interactive animation means for adding and editing animations of various types at the 3D model for the 2D images.

2. The apparatus as recited in claim 1, wherein the image capturing means includes:
a camera installation unit for adjusting a camera diaphragm and focus for the object after turning on a camera;
a memory storage unit for storing 2D images captured from the camera installation unit;
a file conversion unit for converting a 2D image data file that is a digitized file type into a graphic data file that can be used in a graphic program environment;
a data transmission unit for transmitting the graphic file converted in the file conversion unit to a computer database; and
an image database unit for storing the graphic data transmitted by the data transmission unit.

3. The apparatus as recited in claim 2, wherein the basic primitives include cube, plane, pyramid and wedge of a 3D type.

4. The apparatus as recited in claim 3, wherein the 3D model generation means includes:
a first calculation unit for calculating a camera rotation matrix from some line segments of predefined primitives-cube, plane, pyramid and wedge using traditional mathematical geometry algorithm;
a second calculation unit for calculating a camera movement vector and 3D location using the camera rotation matrix obtained from the first calculation unit; and
a authoring unit for storing the camera rotation matrix obtained from the camera rotation matrix from the first calculation unit and the camera movement vector and 3D location from the second calculation unit and providing a suitable initial value for the camera rotation matrix, camera movement vector and 3D location in being requested using the global optimization algorithm.

5. The apparatus as recited in claim 5, wherein the interactive animation means includes:
a lava 3D node picking unit for selecting a node corresponding to a specific part of the 3D model;
a node managing unit for managing the node selected in the java 3D node picking unit;
an event/action setup graphic user interface unit for setting up a necessary action when an specific event is generated;
an event/action list unit for storing events/actions set up in the event/action setup graphic user interface unit; and
a scene graph managing unit for managing all of scene graphs to implement a specific animation.

6. A method for interactive model generating using multi-images, comprising the steps of:
a) capturing means for capturing an arbitrary object as a 2D image using a camera;
b) providing a 3D primitive model granting interactive relation of data between 2D and 3D;
c) matching a predetermined 3D primitive model and the 2D image obtained from the image capturing means;
d) correcting errors generated in capturing the image; and
e) adding and editing animations of various types in the 3D model for the 2D images.

7. A method as recited in claim 7, wherein the step a) includes the steps of:
a1) adjusting a camera diaphragm and focus for the object after turning on a camera;
a2) storing 2D images captured at the step a1);
a3) converting a 2D image data file that is a digitized file type into a graphic data file that can be used in a graphic program environment;
a4) transmitting the graphic file converted at the step a3) to a computer database; and
a5) storing the graphic data transmitted at step a4).

8. A method recited in claim 7, wherein the step b) includes the steps of:
b1) confirming where a specific event is generated among a image display, a 3D model display and the other menu;
b2) loading primitives from a primitive library and editing vertices of the primitives, if the event is generated at the image display;
b3) confirming which part is pushed and which event is generated and implementing the predetermined action according to the confirmed event, if the event is generated at the 3D model display; and
b4) calling an event handler and implementing predetermined actions by the event handler, if the event is generated at the other menu.

9. A method as recited in claim 7, wherein the step c) includes the steps of:
c1) calculating a camera rotation matrix from some line segments of predefined primitives-cube, plane, pyramid and wedge using traditional mathematical geometry algorithm;
c2) calculating a camera movement vector and 3D location using the camera rotation matrix obtained from the camera rotation matrix calculation unit; and
c3) authoring the camera rotation matrix, camera movement vector, 3D direction and location from the first calculation unit and the camera movement vector and 3D location from the second calculation unit in being requested using the global optimization algorithm.

10. A method as recited in claim 7, wherein the step d) includes the steps of:
d1) outputting graphic data from multi-image pictures (hereinafter, texture) database;
d2) detecting errors including hole parts and an occluded parts of the texture;
d3) filling the hole part and the occluded part with suitable image of the other object;
d4) adjusting brightness in order to easily see the image; and
d5) transmitting the texture data in order to renew the texture.

11. A method as recited in claim 7, wherein the step e) includes the steps of:
e1) selecting a node corresponding to a specific part of the 3D model;
e2) managing the node selected at the step e1);
e3) setting up a necessary action when an specific event is generated;
e4) storing events/actions set up at the step e3); and
e5) managing all of scene graphs to implement a specific animation.

12. Computer-readable record media storing instructions for performing the functions of:
capturing means for capturing an arbitrary object as a 2D image using a camera;
providing a 3D primitive model granting interactive relation of data between 2D and 3D;
matching a predetermined 3D primitive model and the 2D image obtained from the image capturing means;
correcting errors generated in capturing the image; and adding and editing animations of various types in the 3D model for the 2D images.
